(19) United States
(12) Patent Application Publication
(10) Pub. No.: US 2026/0106373 A1
(43) Pub. Date: Apr. 16, 2026

(54) ANTENNA MODULE, COMMUNICATION APPARATUS MOUNTING SAME, AND CIRCUIT AND METHOD FOR CONTROLLING AN ANTENNA MODULE

(71) Applicant: Murata Manufacturing Co., Ltd., Nagaokakyo-shi (JP)

(72) Inventors: Yoshiaki HASEGAWA, Nagaokakyo-shi (JP); Ahnwoo LEE, Nagaokakyo-shi (JP)

(73) Assignee: Murata Manufacturing Co., Ltd., Nagaokakyo-shi (JP)

(21) Appl. No.: 19/419,146

(22) Filed: Dec. 15, 2025

Related U.S. Application Data
(63) Continuation of application No. PCT/JP2024/021450, filed on Jun. 13, 2024.

(30) Foreign Application Priority Data
Jul. 21, 2023 (JP) 2023-119147

(51) Int. Cl. H01Q 3/30; H01Q 1/38

(52) U.S. Cl. CPC H01Q 3/30; H01Q 1/38

(57) ABSTRACT

An antenna module includes a dielectric substrate, first to fourth radiating elements disposed in a line at the dielectric substrate, and corresponding first to fourth phase shifting circuits. Each phase shifting circuit adjusts a phase of a high frequency signal to be supplied to a corresponding radiating element and includes N number of phase shifters connected in series. For a minimum resolution R, representing a minimum amount of variation of a phase difference between adjacent radiating elements, a maximum phase difference between the adjacent radiating elements is equal to R×2^{(N-1)}. A maximum phase difference between the first and fourth phase shifting circuits is equal to R×2^{(N-1)}×3. Phases in each of the first and fourth phase shifting circuits are settable at increments of R×3. Phases in each of the second and third phase shifting circuits are settable at increments of R.

### CROSS REFERENCE TO RELATED APPLICATIONS

The present application is bypass continuation of International Application No. PCT/JP2024/021450, filed Jun. 13, 2024, which claims priority to Japanese patent application JP 2023-119147, filed Jul. 21, 2023, the entire contents of each of which being incorporated herein by reference.

### TECHNICAL FIELD

The present disclosure relates to an antenna module and a communication apparatus mounting the same, or more specifically, to a technique for downsizing an array antenna capable of beamforming.

### BACKGROUND ART

International Publication No. 2021/131285 (Patent Document 1) discloses a configuration of an array antenna including multiple radiating elements disposed at a dielectric substrate, in which phase shifters are disposed on signal channels corresponding to the respective radiating elements. The array antenna of International Publication No. 2021/131285 (Patent Document 1) can perform beamforming to change directivity of the entire array antenna by individually adjusting phase degrees of the respective phase shifters.

### CITATION LIST

### Patent Document

Patent Document 1: International Publication No. 2021/131285

### SUMMARY

### Technical Problems

The above-described array antenna is used in a portable terminal such as a mobile phone and a smartphone in some cases.

In a case of performing communication between a base station and a terminal, it is possible to enhance communication quality such as an increase in reception intensity and/or improvement in signal to noise ratio, and to reduce losses inside the devices by matching a direction of radiation and a direction of reception of a radio wave (a beam) between the base station and the terminal by use of beamforming. In this instance, it is considered necessary to render an azimuthal angle of the beam finely settable in order to match the direction of radiation and the direction of reception easily. The azimuthal angle of the beam can be finely set by subdividing unit phase amounts of phase shifting circuits disposed on the signal channels, or resolutions in other words.

Formation of a phase shifting circuit from multiple stages of serially connected phase shifters in association with an increase in number of stages of the phase shifters has heretofore been known as a method of subdividing the resolution of the phase shifting circuit. However, the increase in number of stages of the phase shifters causes an increase in area necessary for forming the phase shifting circuit on the substrate, thus leading to an increase in dimensions of the array antenna as a whole.

While the array antenna is used in a portable terminal in some cases as mentioned above, the portable terminal still faces a strong demand for downsizing and thin profiling of the device, and downsizing of the array antenna itself is also required in association therewith. Accordingly, an increase in dimensions of the array antenna in order to subdivide the resolutions of the phase shifting circuits may bring about an obstacle to the downsizing of the portable terminal.

The present disclosure has been made to solve the aforementioned and other problems, and is directed to subdividing setting of an azimuthal angle of a beam in an antenna module capable of beamforming while suppressing an increase in device dimensions.

### Solutions to Problems

An antenna module according to the present disclosure includes: a dielectric substrate; first to fourth radiating elements disposed in a line at the dielectric substrate; and first to fourth phase shifting circuits. The first to fourth phase shifting circuits are configured to adjust phases of high frequency signals to be supplied to the first to fourth radiating elements, respectively. Each of the first to fourth phase shifting circuits includes N number of phase shifters connected in series. Assuming that a resolution being a minimum amount of variation of a phase difference between the radiating elements located adjacent to each other is R, a maximum phase difference between the radiating elements located adjacent to each other is equal to R×(2^{N}/2). A maximum phase difference between the first phase shifting circuit and the fourth phase shifting circuit is equal to R×(2^{N}/2)×3. Phases in each of the first phase shifting circuit and the fourth phase shifting circuit are settable for every R×3 within a settable range of R×(2^{N}/2)×3. Phases in each of the second phase shifting circuit and the third phase shifting circuit are settable for every R within a settable range of R×(2^{N}/2).

### Advantageous Effects

In the antenna module according to the present disclosure, it is possible to realize a resolution at a traditional level with a smaller number of phase shifters than those in a traditional way by devising combinations of phase setting of the phase shifters. Thus, the antenna module capable of beamforming can subdivide setting of an azimuthal angle of a beam while suppressing an increase in dimensions of the apparatus.

### BRIEF DESCRIPTION OF DRAWINGS

FIG. 1 is a block diagram of a communication apparatus mounting an antenna module according to Embodiment 1.

FIG. 2 is a diagram for explaining configurations of phase shifting circuits in FIG. 1.

FIG. 3 is a diagram showing an example of a circuit configuration of a phase shifter included in a phase shifting circuit.

FIG. 4 is a diagram for explaining phase differences among adjacent radiating elements in beamforming.

FIG. 5 is a diagram for explaining an example of configurations of respective phase shifters in the antenna module according to the Embodiment 1.

FIG. 6 is a diagram for explaining setting of the phase shifting circuits for realizing an azimuthal angle of a beam in the case of FIG. 5.

FIG. 7 is a diagram for explaining configurations of respective phase shifters in an antenna module of a comparative example.

FIG. 8 is a diagram for explaining setting of phase shifting circuits for realizing an azimuthal angle of a beam in the case of FIG. 7.

FIG. 9 is a diagram for explaining configurations of respective phase shifters in an antenna module of Modification 1.

FIG. 10 is a diagram for explaining setting of phase shifting circuits for realizing an azimuthal angle of a beam in the case of FIG. 9.

FIG. 11 is a diagram for explaining configurations of respective phase shifters in an antenna module of Modification 2.

FIG. 12 is a diagram for explaining setting of phase shifting circuits for realizing an azimuthal angle of a beam in the case of FIG. 11.

FIG. 13 is a diagram for explaining an example of configurations of respective phase shifters in an antenna module of Embodiment 2.

FIG. 14 is a diagram for explaining setting of phase shifting circuits for realizing an azimuthal angle of a beam in the case of FIG. 13.

### DESCRIPTION OF EMBODIMENTS

Embodiments of the present disclosure will be described below in detail with reference to the drawings. Note that identical or equivalent portions in the drawings will be denoted by the same reference signs and explanations thereof will not be repeated.

### Embodiment 1

### (Basic Configuration of Communication Apparatus)

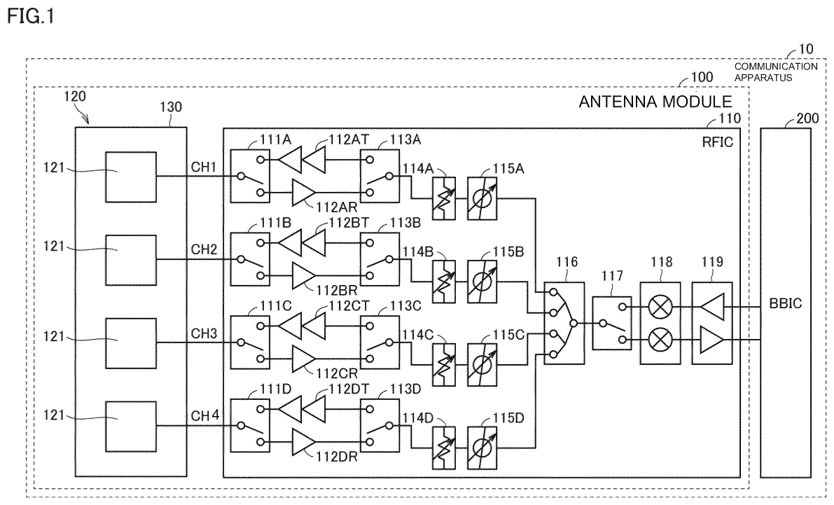

FIG. 1 is an example of a block diagram of a communication apparatus 10 according to Embodiment 1. For example, the communication apparatus 10 is any of a portable terminal such as a mobile phone, a smartphone, and a tablet, a personal computer equipped with a communication function, a base station, and the like. An example of a frequency band of a radio wave used by an antenna module 100 according to the Embodiment 1 is a millimeter waveband of a radio wave with a center frequency of 28 GHz, 39 GHz, 60 GHz, or the like, for instance. However, the present disclosure is also applicable to radio waves in a frequency band other than the aforementioned frequency band.

With reference to FIG. 1, the communication apparatus 10 includes the antenna module 100, and a BBIC 200 that constitutes a baseband signal processing circuit. The antenna module 100 includes an RFIC 110 being an example of a power supply circuit, and an antenna device 120. The communication apparatus 10 up-converts a signal transmitted from the BBIC 200 to the antenna module 100 into a high frequency signal and radiates the high frequency signal from the antenna device 120, and down-converts a high frequency signal received by the antenna device 120 and processes the signal with the BBIC 200.

The antenna device 120 of the Embodiment 1 is an array antenna in which multiple radiating elements 121 are disposed at a dielectric substrate 130. FIG. 1 shows an example of a case of a one-dimensional array of disposing four radiating elements 121 in a line at the dielectric substrate 130 in order to facilitate explanations. Here, the antenna device 120 may be an array antenna in which multiple radiating elements 121 are disposed in the form of a two-dimensional array instead. While the Embodiment 1 will describe a patch antenna having a substantially square flat plate shape as an example of the radiating element 121, the shape of the radiating element 121 may be any of a circle, an ellipse, or other polygons such as a hexagon.

The RFIC 110 includes switches 111A to 111D, 113A to 113D, and 117, power amplifiers 112AT to 112DT, low noise amplifiers 112AR to 112DR, attenuators 114A to 114D, phase shifting circuits 115A to 115D, a signal multiplexer-demultiplexer 116, a mixer 118, and an amplification circuit 119.

In a case of transmitting a high frequency signal, the switches 111A to 111D and 113A to 113D are switched to the power amplifiers 112AT to 112DT sides and the switch 117 is connected to a transmission side amplifier of the amplification circuit 119. In a case of receiving a high frequency signal, the switches 111A to 111D and 113A to 113D are switched to the low noise amplifiers 112AR to 112DR sides and the switch 117 is connected to a reception side amplifier of the amplification circuit 119.

The signal transmitted from the BBIC 200 is amplified by the amplification circuit 119, and is up-converted by the mixer 118. The transmission signal being the up-converted high frequency signal is demultiplexed into four waves by the signal multiplexer-demultiplexer 116, which are passed through four signal channels (channels CH1 to CH4), and are fed to the radiating elements 121 that are different from one another. In this instance, directivity of the antenna device 120 can be adjusted by individually adjusting phase shifting degrees of the phase shifting circuits 115A to 115D disposed at the respective signal channels. In addition, the attenuators 114A to 114D adjust intensities of the transmission signals.

Reception signals being high frequency signals received by the respective radiating elements 121 are routed through the four different signal channels CH1 to CH4, and are multiplexed by the signal multiplexer-demultiplexer 116. The multiplexed reception signal is down-converted by the mixer 118, amplified by the amplification circuit 119, and transmitted to the BBIC 200.

The RFIC 110 is formed as a one-chip integrated circuit component including the above-described circuit configuration, for example. Alternatively, devices (the switch, the power amplifier, the low noise amplifier, the attenuator, and the phase shifting circuit) corresponding to each radiating element 121 in the RFIC 110 may be formed as one-chip integrated circuit component for each corresponding radiating element 121.

### (Configurations of Phase Shifting Circuits)

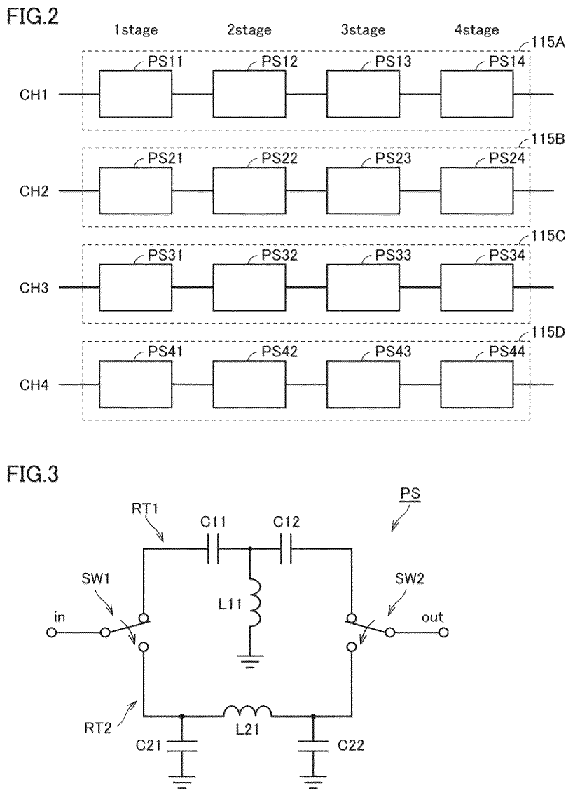

FIG. 2 is a diagram for explaining configurations of the phase shifting circuits 115A to 115D in FIG. 1. Each phase shifting circuit is formed from N multiple phase shifters connected in series. In the example of FIG. 2, each phase shifting circuit includes four phase shifters. For instance, the channel CH1 includes phase shifters PS11 to PS14, and the channel CH2 includes phase shifters PS21 to PS24. In addition, the channel CH3 includes phase shifters PS31 to PS34, and the channel CH4 includes phase shifters PS41 to PS44. While FIG. 2 illustrates an example where N=4, the number of stages may vary, as described in the embodiments below.

Each phase shifter is configured to be capable of switching between two phases as shown in FIG. 3, for instance. The phase shifter PS in the example of FIG. 3 is configured to switch between two routes RT1 and RT2 by using a switch SW1 connected to an input terminal in and a switch SW2 connected to an output terminal out.

The route RT1 includes capacitors C11 and C12 connected in series between the switch SW1 and the switch SW2, and a shunt inductor L11 connected to a connection node of these capacitors. In addition, the route RT2 includes an inductor L21 connected between the switch SW1 and the switch SW2, a shunt capacitor C21 connected to one end of the inductor L21, and a shunt capacitor C22 connected to another end of the inductor L21.

A phase is changed in an advancing direction when the switches SW1 and SW2 are switched to the route RT1, and is changed in a delaying direction when the switches SW1 and SW2 are switched to the route RT2. An amount of change in phase can be adjusted by adjusting capacitance values of the capacitors and an inductance value of the inductor in each route.

Note that the configuration of the phase shifters PS shown in FIG. 3 is an example, and a circuit to be formed in each route may be a different circuit as long as the phase of one route is set in the advancing direction or the delaying direction relative to the phase of the other route. For example, both of the routes RT1 and RT2 may include circuits in the direction to delay the phase and the phase on the route RT2 may be set to be delayed more than the phase on the route RT1. In this case, the respective phases can be set only by adjusting route lengths of the routes RT1 and RT2 without using the elements such as the inductors and the capacitors, so that the circuit configuration of the phase shifters PS can be simplified.

### (Explanation of Beamforming)

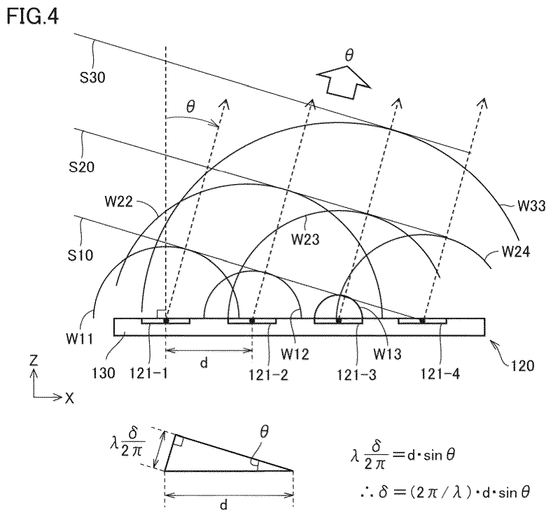

Next, a phase difference between adjacent radiating elements in the case of carrying out beamforming will be explained by using FIG. 4. A case of carrying out beamforming of a main beam at an azimuthal angle of θ from a normal direction (z axis direction) of the dielectric substrate 130 with the antenna device 120 of the one-dimensional array in which the four radiating elements 121 are disposed in a line in the x axis direction as shown in FIG. 1 will be considered with reference to FIG. 4 and the interelement distance will be defined as d.

In this instance, the main beam is radiated at the azimuthal angle θ as a consequence of sequential delays of phases of radio waves radiated from a radiating element 121-1 in a positive direction of the x axis. For example, a wave surface having the same phase as a certain wave surface W11 of the radio wave radiated from the radiating element 121-1 is a wave surface W12 in the case of a radiating element 121-2 or a wave surface W13 in the case of a radiating element 121-3. Accordingly, assuming that an isophase surface in contact of these wave surfaces having the same phase is denoted by reference sign S10, the radio waves propagate in a direction perpendicular to the isophase surface S10. Likewise, regarding a wave surface advancing just by one wavelength λ from the isophase surface S10, an isophase surface S20 is formed by a wave surface W22 of the radio wave from the radiating element 121-2, a wave surface W23 of the radio wave from the radiating element 121-3, a wave surface W24 of the radio wave from a radiating element 121-4, and the like. Moreover, regarding a wave surface further advancing just by one wavelength λ therefrom, an isophase surface S30 is formed by a wave surface W33 of the radio wave from the radiating element 121-3 and the like.

Assuming that a phase difference between the adjacent elements is δ, a relation defined by the following formula (1) holds true:

$$λ ( δ / 2 π ) = d \cdot sin θ . \qquad ( 1 )$$

Accordingly, the phase difference δ is derived from the formula (1) as described below:

$$δ = ( 2 π / λ ) \cdot d \cdot sin θ . \qquad ( 2 )$$

In general, an interelement distance d is often set equal to λ/2, the formula (2) is modified into formula (3) in the case of setting d=λ/2;

$$δ = π \cdot sin θ . \qquad ( 3 )$$

That is to say, the azimuthal angle θ of the main beam can be set by adjusting the phase difference δ between the adjacent elements. Accordingly, when the phase difference δ between the adjacent elements is equal to 90° (=π/2), for example, the azimuthal angle θ of the main beam is equal to 30°.

FIG. 5 is a diagram for explaining an example of configurations of the respective phase shifters in the antenna module 100 according to the Embodiment 1. In the example of FIG. 5, each of the phase shifting circuits 115A to 115D is formed from three phase shifters. FIG. 5 shows phase angles settable with the respective phase shifters.

In the phase shifting circuit 115A, the phase shifter PS11 is configured to be switchable between phases at 0° and at 67.5°. In addition, the phase shifter PS12 is switchable between phases at −67.5° and at 0°, and the phase shifter PS13 is switchable between phases at −67.5° and at 67.5°.

In the phase shifting circuit 115B, the phase shifter PS21 is configured to be switchable between phases at 0° and at 22.5°. In addition, the phase shifter PS22 is switchable between phases at −22.5° and at 22.5°, and the phase shifter PS23 is switchable between phases at −45.0° and at 22.5°.

In the phase shifting circuit 115C, the phase shifter PS31 is configured to be switchable between phases at 0° and at 22.5°. In addition, the phase shifter PS32 is switchable between phases at −22.5° and at 22.5°, and the phase shifter PS33 is switchable between phases at −45.0° and at 22.5°.

In the phase shifting circuit 115D, the phase shifter PS41 is configured to be switchable between phases at 0° and at 67.5°. In addition, the phase shifter PS42 is switchable between phases at −67.5° and at 0°, and the phase shifter PS43 is switchable between phases at −67.5° and at 67.5°.

Each phase shifting circuit can adjust the phase in the relevant phase shifting circuit by appropriately switching the phases of the three phase shifters.

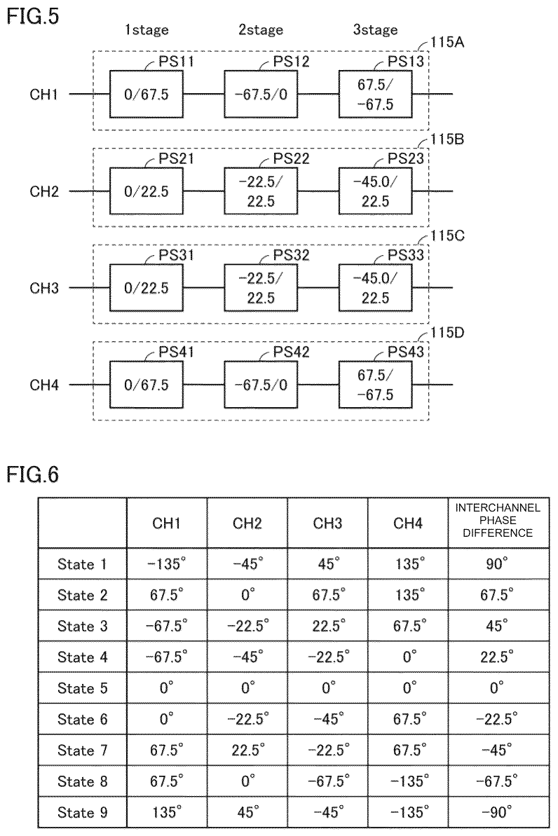

FIG. 6 is a diagram for explaining setting of the phase shifting circuits for realizing the azimuthal angle of the beam in the case of FIG. 5. As described in FIG. 4, the azimuthal angle θ of the beam can be adjusted by the phase difference δ between the adjacent elements. FIG. 6 shows the phases in the phase shifting circuits of the respective channels in the case of changing the phase difference between certain channels from −90° to 90° at a pitch (the resolution) of 22.5°.

In the case of setting an interchannel phase difference equal to 90°, for example, the phases of the channels CH1 to CH4 are set equal to −135°, −45°, 45°, and 135°, respectively.

More specifically, in the phase shifting circuit 115A of the channel CH1, the phase of the phase shifter PS11 is set equal to 0° while the phases of the phase shifter PS12 and the phase shifter PS13 are set equal to −67.5°. In the phase shifting circuit 115B of the channel CH2, the phase of the phase shifter PS21 is set equal to 22.5°, the phase of the phase shifter PS22 is set equal to −22.5°, and the phase of the phase shifter PS23 is set equal to −45°.

In the phase shifting circuit 115C of the channel CH3, the phase of the phase shifter PS31 is set equal to 0° while the phases of the phase shifter PS32 and the phase shifter PS33 are set equal to 22.5°. In the phase shifting circuit 115D of the channel CH4, the phases of the phase shifter PS41 and the phase shifter PS43 are set equal to 67.5° while the phase of the phase shifter PS42 is set equal to 0°.

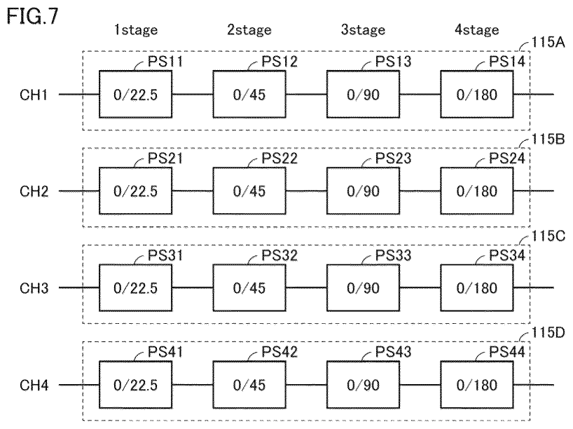

FIG. 7 is a diagram for explaining configurations of respective phase shifters in an antenna module of a comparative example that has heretofore been used.

In the antenna module of the comparative example, each of phase shifting circuits 115A to 115D has the same configuration including four stages of phase shifters. More specifically, each of phase shifters PS11, PS21, PS31, and PS41 on the first stage is switchable between phases at 0° and at 22.5°. Each of phase shifters PS12, PS22, PS32, and PS42 on the second stage is switchable between phases at 0° and at 45°. Each of phase shifters PS13, PS23, PS33, and PS43 on the third stage is switchable between phases at 0° and at 90°. Each of phase shifters PS14, PS24, PS34, and PS44 on the fourth stage is switchable between phases at 0° and at 180°.

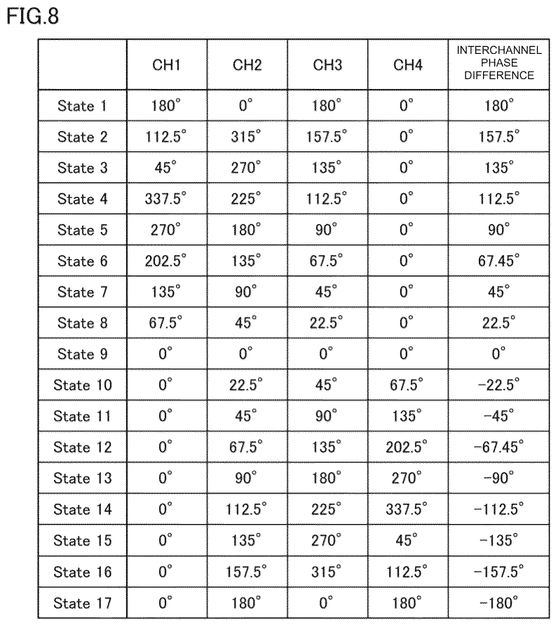

FIG. 8 is a diagram for explaining setting of the phase shifting circuits 115A and 115D for realizing the azimuthal angle of the beam in the case of FIG. 7. As shown in FIG. 8, the antenna module of the comparative example can set the interchannel phase difference from −180° to 180° at the resolution of 22.5°.

In the case of providing the respective phase shifting circuit with the same configuration as in the comparative example, it is necessary to increase the number of stages of the phase shifters in each phase shifting circuit in the case of subdividing the resolution of the interchannel phase difference. In the case of changing the interchannel phase difference at the resolution of 22.5°, for example, each phase shifting circuit needs four stages of phase shifters. However, the increase in number of stages of the phase shifters enlarges the area of the phase shifters in the RFIC, thus leading to an increase in dimensions of the entire array antenna. Accordingly, this increase is likely to constitute an obstructive factor against a demand for further reduction in size of the apparatus.

In the antenna module 100 of the Embodiment 1 described with reference to FIG. 5 and FIG. 6, the same resolution as the case of using the phase shifting circuits of the comparative example having the four-stage structure is realized with the phase shifting circuits having the three-stage structure by providing the different setting of the phase shifters in the phase shifting circuits depending on the channels.

Here, in the antenna module 100 of the Embodiment 1, the phase difference between the adjacent elements, that is to say, the interchannel phase difference is set to 90° at the maximum which is smaller than the maximum phase difference of 180° in the comparative example. In other words, in the antenna module 100, the maximum azimuthal angle θ of the beam is narrower than that in the antenna module of the comparative example. Specifically, the antenna module 100 of the Embodiment 1 has the values θ=±30° whereas the comparative example has the values θ=±90°.

Nevertheless, from a practical point of view, the beam is radiated less often at the azimuthal angle θ of 90°, that is to say, in a transverse direction. A range of coverage according to the specifications is satisfied enough in many cases as long as it is possible to carry out beamforming in a range of 60°(θ=±30°). Accordingly, by appropriately setting the respective phase shifters while reducing the number of stages of the phase shifters constituting the phase shifting circuits as in the antenna module 100 of the Embodiment 1, it is possible to subdivide the azimuthal angle of the beam to an equivalent level to the phase shifting circuits having the four-stage structure while reducing a mounting area of the RFIC 110 and suppressing the increase in dimensions of the apparatus. In addition, the reduction in number of stages of the phase shifters can reduce losses in the respective signal channels.

The setting of the phase shifting circuits in the Embodiment 1 can be generalized as follows.

The number of the phase shifters included in each phase shifting circuit will be defined as N and a minimum amount of variation (the resolution) of the phase difference between the radiating elements located adjacent to each other will be defined as R. In this instance, the maximum phase difference (the interchannel phase difference) between the radiating elements located adjacent to each other can be expressed as R×(2^{N}/2), i.e., R×2^{(N-1)}, and the maximum phase difference between the channel CH1 and the channel CH4 can be expressed as R×(2^{N}/2)×3.

In the case of the three-stage structure (N=3) and the resolution R=22.5° as in the above-described example, the maximum interchannel phase difference is 22.5°×(2³/2)=90° as shown in the examples of “State 1” and “State 9” in FIG. 6, and the maximum phase difference between the channel CH1 and the channel CH4 is equal to 270°.

In addition, the phases of the channels CH1 and CH4 can be expressed as settable for every R×3 within a settable range of R×(2^{N}/2)×3, and the phases of the channels CH2 and CH3 can be expressed as settable for every R within a settable range of R×(2^{N}/2).

In the case of the examples in FIG. 6, the settable range of the phases of the channels CH1 and CH4 is equivalent to 270° from −135° to 135°, which is settable for every 67.5°. In addition, the settable range of the phases of the channels CH2 and CH3 is equivalent to 90° from −45° to 45°, which is settable for every 22.5°.

The “radiating elements 121” in the Embodiment 1 correspond to “first to fourth radiating elements” in the present disclosure. The “phase shifting circuits 115A to 115D” in the Embodiment 1 correspond to “first to fourth phase shifting circuits” in the present disclosure, respectively.

### Modification 1

In the antenna module 100 of the Embodiment 1, the case of setting the phases in the advancing direction (phases in a negative side) and the phases in the delaying direction (phases in a positive side) to the phase shifters in the phase shifting circuits has been described.

Modification 1 will describe a configuration to offset setting of respective phase shifters in whole so as to define phases settable to the respective phase shifters to phases in the delaying direction while maintaining relative phase differences among channels. In this case, there is an advantage that the configuration of each phase shifter can be simplified as has also been described in FIG. 3.

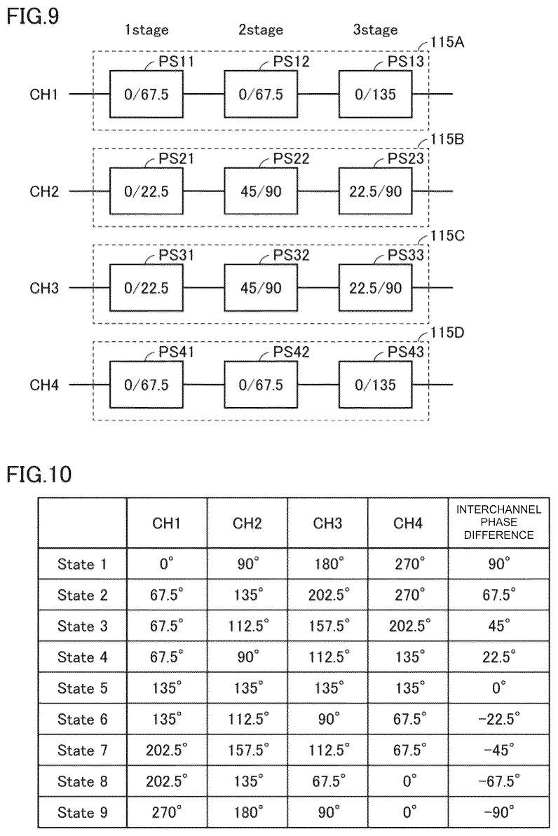

FIG. 9 is a diagram for explaining configurations of respective phase shifters in an antenna module of the Modification 1. In addition, FIG. 10 is a diagram for explaining setting of phase shifting circuits for realizing an azimuthal angle of a beam in the case of FIG. 9.

With reference to FIG. 9, in the antenna module of the Modification 1, each of phase shifting circuits 115A to 115D includes three stages of phase shifters connected in series as with the antenna module 100 of the Embodiment 1. However, setting of phase shifters PS12, PS22, PS32, and PS42 on the second stage and of phase shifters PS13, PS23, PS33, and PS43 on the third stage in the respective phase shifting circuits is offset just by +67.5° as compared to the case of FIG. 5.

Specifically, in the phase shifting circuits 115A and 115D, the phase shifters PS12 and PS42 on the second stage are switchable between phases at 0° and at 67.5° while the phase shifters PS13 and PS43 on the third stage are switchable between phases at 0° and at 135°. Likewise, in the phase shifting circuits 115B and 115C, the phase shifters PS22 and PS32 on the second stage are switchable between phases at 45° and at 90° while the phase shifters PS23 and PS33 on the third stage are switchable between phases at 22.5° and at 90°.

By setting as described above, the interchannel phase difference can be set at the same resolution as that of the antenna module 100 of the Embodiment 1 while adjusting the phases of the respective channels in the delaying direction as shown in FIG. 10. Accordingly, it is possible to realize suppression of an increase in dimensions of the apparatus, subdivision of the azimuthal angle of the beam, and reduction in loss in each signal channel while further simplifying the configuration of each phase shifter.

### Modification 2

Modification 2 will describe a configuration to expand the range of coverage by using phase shifting circuits having the three-stage structure as with the Embodiment 1.

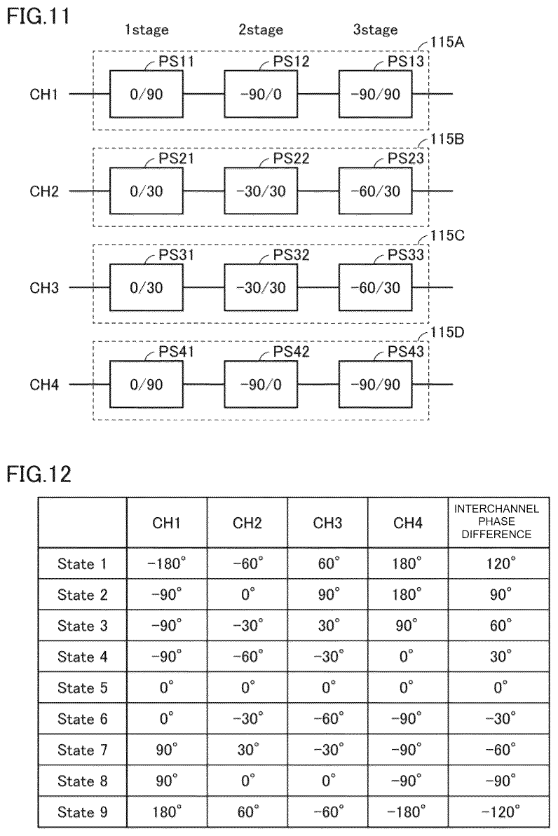

FIG. 11 is a diagram for explaining configurations of respective phase shifters in an antenna module of the Modification 2. In addition, FIG. 12 is a diagram for explaining setting of phase shifting circuits for realizing an azimuthal angle of a beam in the case of FIG. 11.

With reference to FIG. 11, in the antenna module of the Modification 2, each of phase shifting circuits 115A to 115D includes three stages of phase shifters connected in series as with the antenna module 100 of the Embodiment 1. However, setting of phase shifters in each phase shifting circuit is different.

Specifically, in the phase shifting circuits 115A and 115D, phase shifters PS11 and PS41 on the first stage are switchable between phases at 0° and at 90°, phase shifters PS12 and PS42 on the second stage are switchable between phases at −90° and at 0°, and phase shifters PS13 and PS43 on the third stage are switchable between phases at −90° and at 90°. Likewise, in the phase shifting circuits 115B and 115C, phase shifters PS21 and PS31 on the first stage are switchable between phases at 0° and at 30°, phase shifters PS22 and PS32 on the second stage are switchable between phases at −30° and at 30°, and phase shifters PS23 and PS33 on the third stage are switchable between phases at −60° and at 30°.

By setting as described above, the interchannel phase difference can be changed at the resolution of 30° from −120° to 120° as shown in FIG. 12. That is to say, the Modification 2 can realize the range of coverage of ±42° as the azimuthal angle θ although the resolution is slightly larger as compared to the Embodiment 1. By appropriately changing the phases of the respective phase shifters depending on the resolution and the range of coverage required therefrom as described above, it is possible to realize suppression of an increase in dimensions of the apparatus and reduction in loss in each signal channel while satisfying required specifications.

Here, the increase in value of the resolution makes it difficult to match the direction of radiation and the direction of reception of the beam between the base station and the terminal. Accordingly, it is desirable to set the resolution around 45° at the maximum.

### Embodiment 2

The Embodiment 1 has described the circuit configuration to realize the phase shifting circuits, which have heretofore been formed by four stages of the phase shifters, by the three-stage structure with the equivalent resolution.

Embodiment 2 will describe circuit configurations to realize phase shifting circuits, which have heretofore adopted a five-stage structure, by a four-stage structure in order to further subdivide the resolution.

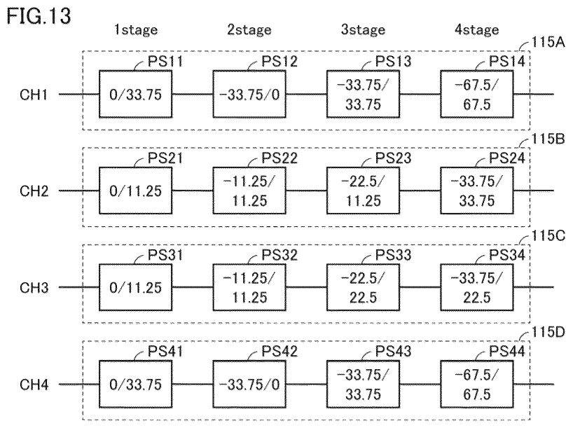

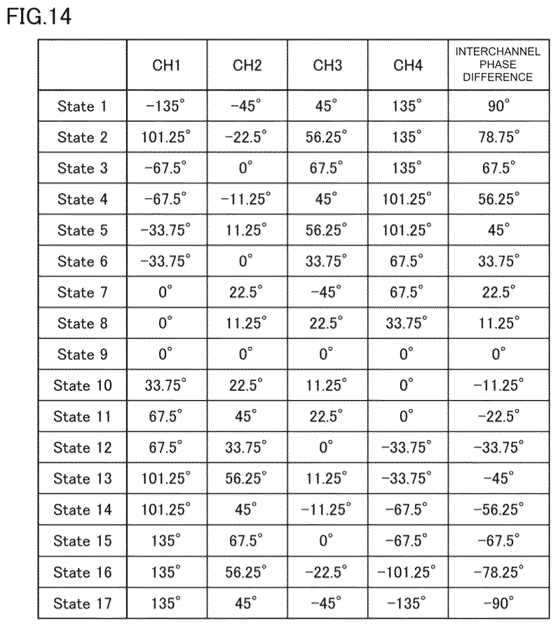

FIG. 13 is a diagram for explaining an example of configurations of respective phase shifters in an antenna module of the Embodiment 2. In addition, FIG. 14 is a diagram for explaining setting of phase shifting circuits for realizing an azimuthal angle of a beam in the case of FIG. 13.

In the antenna module of the Embodiment 2, the resolution of the interchannel phase difference is set equal to 11.25°, which is a half as compared to the case of the Embodiment 1. Each of phase shifting circuits 115A to 115D is formed from four phase shifters connected in series.

In the phase shifting circuit 115A, a phase shifter PS11 is configured to be switchable between phases at 0° and at 33.75°. In addition, a phase shifter PS12 is switchable between phases at −33.75° and at 0°. A phase shifter PS13 is switchable between phases at −33.75° and at 33.75°, and a phase shifter PS14 is switchable between phases at −67.5° and at 67.5°.

In the phase shifting circuit 115B, a phase shifter PS21 is configured to be switchable between phases at 0° and at 11.25°. In addition, a phase shifter PS22 is switchable between phases at −11.25° and at 11.25°. A phase shifter PS23 is switchable between phases at −22.5° and at 11.25°, and a phase shifter PS24 is switchable between phases at −33.75° and at 33.75°.

In the phase shifting circuit 115C, a phase shifter PS31 is configured to be switchable between phases at 0° and at 11.25°. In addition, a phase shifter PS32 is switchable between phases at −11.25° and at 11.25°. A phase shifter PS33 is switchable between phases at −22.5° and at 22.5°, and a phase shifter PS34 is switchable between phases at −33.75° and at 22.5°.

In the phase shifting circuit 115D, a phase shifter PS41 is configured to be switchable between phases at 0° and at 33.75°. In addition, a phase shifter PS42 is switchable between phases at −33.75° and at 0°. A phase shifter PS43 is switchable between phases at −33.75° and at 33.75°, and a phase shifter PS44 is switchable between phases at −67.5° and at 67.5°.

By setting the respective phase shifters as described above, the interchannel phase difference can be changed at the resolution of 11.25° in a range from −90° to 90°. Moreover, as shown in FIG. 14, the phase can be set for every 33.75° within the settable range of 270° (−135° to 135°) regarding the channels CH1 and CH4. In addition, the phase can be set for every 11.25° within the settable range of 90° (−45° to 45°) regarding the channels CH2 and CH3.

In other words, in the case of the four-stage structure (N=4) and the resolution R=11.25°, the maximum interchannel phase difference is 11.25°×(2⁴/2)=90° and the maximum phase difference between the channel CH1 and the channel CH4 is 11.25°×(2⁴/2)×3=270°. In addition, the settable range of the phase of the channel CH1 and the channel CH4 is equal to 270° from −135° to 135°, which is settable for every 33.75°. In addition, the settable range of the phase of the channel CH2 and the channel CH3 is equal to 90° from −45° to 45°, which is settable for every 11.25°.

As described above, the Embodiment 2 can realize the resolution of 11.25°, which has heretofore been realized by the phase shifting circuits having the five-stage structure, by the phase shifting circuits having the four-stage structure. Accordingly, it is possible to realize suppression of an increase in dimensions of the apparatus, subdivision of the azimuthal angle of the beam, and reduction in loss in each signal channel.

### Aspects

It is understood by a person skilled in the art that the above-described multiple exemplary embodiments represent specific examples of the following aspects.
(Aspect 1) An antenna module according to an aspect includes: a dielectric substrate; first to fourth radiating elements disposed in a line at the dielectric substrate; and first to fourth phase shifting circuits. The first to fourth phase shifting circuits are configured to adjust phases of high frequency signals to be supplied to the first to fourth radiating elements, respectively. Each of the first to fourth phase shifting circuits includes N number of phase shifters connected in series. Assuming that a resolution being a minimum amount of variation of a phase difference between the radiating elements located adjacent to each other is R, a maximum phase difference between the radiating elements located adjacent to each other is equal to R×(2^{N}/2). A maximum phase difference between the first phase shifting circuit and the fourth phase shifting circuit is equal to R×(2^{N}/2)×3. Phases in each of the first phase shifting circuit and the fourth phase shifting circuit are settable for every R×3 within a settable range of R×(2^{N}/2)×3, i.e., are settable in increments of R×3. Phases in each of the second phase shifting circuit and the third phase shifting circuit are settable for every R within a settable range of R×(2^{N}/2), i.e., are settable in increments of R.
(Aspect 2) In the antenna module according to aspect 1, a maximum value of the resolution is equal to 45°.
(Aspect 3) In the antenna module according to aspect 2, the resolution is equal to any one of 11.25°, 22.5°, and 30°.
(Aspect 4) In the antenna module according to any one of aspects 1 to 3, a quantity of the phase shifters included in each of the first to fourth phase shifting circuits is equal to 3 or 4.
(Aspect 5) In the antenna module according to any one of aspects 1 to 4, a minimum phase in each of the first phase shifting circuit and the fourth phase shifting circuit is equal to 0°.
(Aspect 6) In the antenna module according to any one of aspects 1 to 5, each of the phase shifters is configured to be switchable between two phases.
(Aspect 7) A communication apparatus including: the antenna module according to any one of aspects 1 to 6 mounted on the apparatus.

The embodiments disclosed herein should be considered as being exemplary in all aspects and not being restrictive. The scope of the present invention is defined not by the explanations of the above-described embodiments but instead by the appended claims. It is intended that the present invention encompasses all modifications within the meanings and the scope equivalent to the appended claims.

### REFERENCE SIGNS LIST

10 communication apparatus, 100 antenna module, 110 RFIC, 111A to 111D, 113A to 113D, 117, SW1, and SW2 switch, 112AR to 112DR low noise amplifier, 112AT to 112DT power amplifier, 114A to 114D attenuator, 115A to 115D phase shifting circuit, 116 signal multiplexer-demultiplexer, 118 mixer, 119 amplification circuit, 120 antenna device, 121 radiating element, 130 dielectric substrate, 200 BBIC, C11, C12, C21, C22 capacitor, CH1 to CH4 channel, L11, L21 inductor, PS, PS11 to PS14, PS21 to PS24, PS31 to PS34, PS41 to PS44 phase shifter, RT1, RT2 route, in input terminal, out output terminal

1. An antenna module comprising:
a dielectric substrate;
first, second, third and fourth radiating elements disposed in a line at the dielectric substrate; and
first, second, third, and fourth phase shifting circuits configured to adjust phases of high frequency signals to be supplied to the first, second, third and fourth radiating elements, respectively, wherein
each of the first to fourth phase shifting circuits includes N number of phase shifters connected in series, and
wherein, for a minimum resolution R, representing a minimum amount of variation of a phase difference between adjacent radiating elements,
a maximum phase difference between the radiating elements located adjacent to each other is equal to R×2^{(N-1)},
a maximum phase difference between the first phase shifting circuit and the fourth phase shifting circuit is equal to R×2^{(N-1)}×3,
phases in each of the first phase shifting circuit and the fourth phase shifting circuit are settable increments of R×3, and
phases in each of the second phase shifting circuit and the third phase shifting circuit are settable in increments of R.

2. The antenna module according to claim 1, wherein a maximum value of the resolution is equal to 45°.

3. The antenna module according to claim 2, wherein the resolution is equal to any one of 11.25°, 22.5°, and 30°.

4. The antenna module according to any claim 1, wherein a quantity of the phase shifters included in each of the first to fourth phase shifting circuits is equal to 3 or 4.

5. The antenna module according to any claim 1, wherein a minimum phase in each of the first phase shifting circuit and the fourth phase shifting circuit is equal to 0°.

6. The antenna module according to claim 1, wherein each of the phase shifters is configured to be switchable between two phases.

7. The antenna module according to claim 6, wherein each of the phase shifters includes an input terminal, an output terminal, a first signal route, and a second signal route, wherein a selection between the first signal route and the second signal route provides one of the two phases.

8. The antenna module according to claim 1, wherein the first, second, third, and fourth phase shifting circuits are integrated within a single Radio Frequency Integrated Circuit (RFIC).

9. The antenna module according to claim 8, wherein the RFIC further comprises a plurality of power amplifiers and a plurality of low noise amplifiers coupled to the first, second, third, and fourth phase shifting circuits.

10. A communication apparatus comprising:
the antenna module according to claim 1 mounted on the apparatus.

11. A method for controlling an antenna module having first, second, third, and fourth radiating elements disposed in a line, the method comprising:
providing first, second, third, and fourth phase shifting circuits coupled to the first, second, third, and fourth radiating elements, respectively, wherein each phase shifting circuit includes a number N of serially connected phase shifters;
supplying a high frequency signal to each of the phase shifting circuits; and
adjusting, via the phase shifters, a phase of the high frequency signal at each phase shifting circuit to form a beam,
wherein adjusting the phase includes:
setting a phase of the first and fourth phase shifting circuits with a first incremental step size; and
setting a phase of the second and third phase shifting circuits with a second incremental step size, the second incremental step size being smaller than the first incremental step size.

12. The method according to claim 11, wherein the first incremental step size is three times the second incremental step size.

13. A Radio Frequency Integrated Circuit (RFIC) for controlling an antenna array having at least four radiating elements, the RFIC comprising:
first, second, third, and fourth signal channels, each configured to output a high frequency signal;
a first phase shifting circuit in the first signal channel;
a second phase shifting circuit in the second signal channel;
a third phase shifting circuit in the third signal channel; and
a fourth phase shifting circuit in the fourth signal channel,
wherein each phase shifting circuit includes a plurality of serially connected phase shifters, and
wherein a configuration of the phase shifters in the first and fourth phase shifting circuits provides a phase adjustment range and step size different from a configuration of the phase shifters in the second and third phase shifting circuits.

14. The RFIC of claim 13, wherein the phase shifters of the second and third phase shifting circuits are configured to provide a finer phase adjustment step size than the phase shifters of the first and fourth phase shifting circuits.

15. The RFIC of claim 13, wherein each of the phase shifters is configured to be switchable between two phases.
